(19) United States
(12) Patent Application Publication
(10) Pub. No.: US 2026/0270042 A1
(43) Pub. Date: Sep. 10, 2026

(54) DATA INTEGRITY VALIDATION DURING MIGRATION OF DATA BETWEEN INFORMATION HANDLING SYSTEMS

(71) Applicant: DELL PRODUCTS L.P., Round Rock, TX (US)

(72) Inventors: Parminder Singh Sethi, Ludhiana (IN); Trinto TA, New Technologies (IN); Praveen Kumar, Noida (IN); Avinash Kumar, Patna (IN)

(21) Appl. No.: 19/073,756

(22) Filed: Mar. 7, 2025

(51) Int. Cl. H04L 9/06; H04L 9/32

(52) U.S. Cl. CPC H04L 9/0643; H04L 9/3247

(57) ABSTRACT

An information handling system is configured to initiate a data transfer request from a first information handling system to a second information handling system and receive a response to the data transfer request from the second information handling system, wherein the response includes security configuration information. The information handling system is also configured to establish a secure data channel between the first information handling system and the second information handling system based on the security configuration information subsequent to the receipt of the response. In addition, the information handling system is configured to transfer data from the first information handling system to the second information handling system via the secure data channel.

### FIELD OF THE DISCLOSURE

The present disclosure generally relates to information handling systems, and more particularly relates to data integrity validation during migration of data between information handling systems.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system is configured to initiate a data transfer request from a first information handling system to a second information handling system and receive a response to the data transfer request from the second information handling system, wherein the response includes security configuration information. The information handling system is also configured to establish a secure data channel between the first information handling system and the second information handling system based on the security configuration information subsequent to the receipt of the response. In addition, the information handling system is configured to transfer data from the first information handling system to the second information handling system via the secure data channel.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an environment for data integrity validation during migration of data between information handling systems, according to an embodiment of the present disclosure;

FIG. 2 is a sequence diagram of a method for data integrity validation during migration of data between information handling systems, according to an embodiment of the present disclosure; and

FIG. 3 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

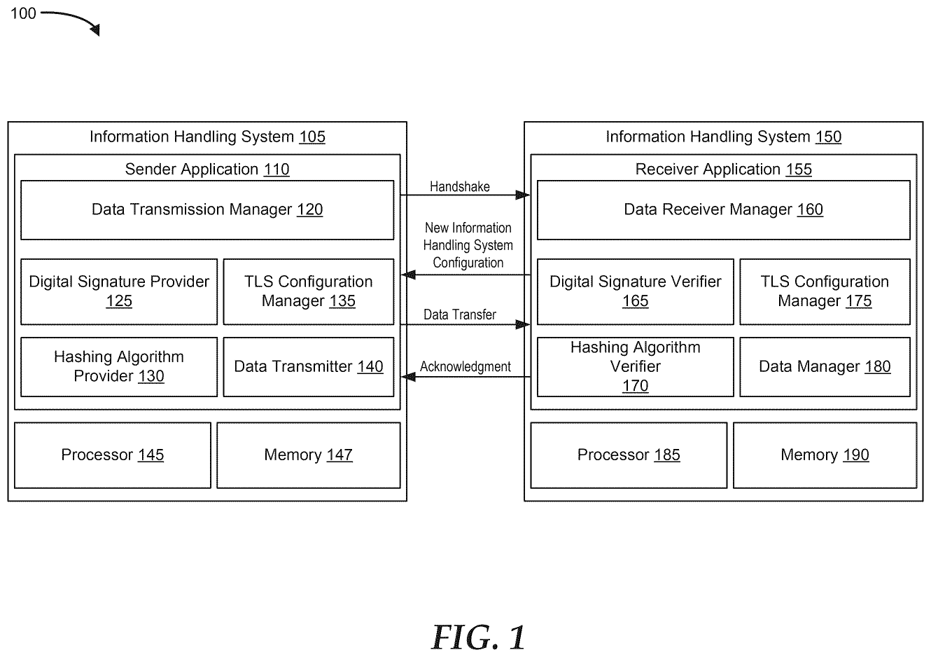

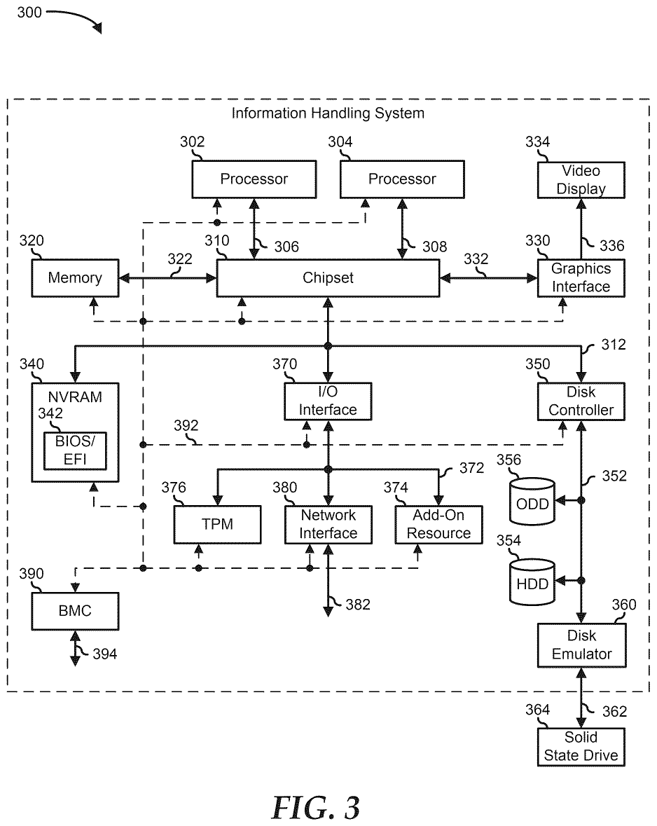

FIG. 1 illustrates a portion of an environment 100 for data integrity validation during the migration of data between information handling systems, according to an embodiment of the present disclosure. Environment 100 includes an information handling system 105 and an information handling system 150, which are both similar to an information handling system 300 of FIG. 3. Information handling system 105 may be communicatively coupled to information handling system 150, such as via a network. The network may be a public network, such as the Internet, a physical private network, a wireless network, a virtual private network (VPN), or any combination thereof.

Information handling system 105 includes a sender application 110, a processor 145, and a memory 147. Sender application 110 includes a data transmission manager 120, a digital signature provider 125, a hashing algorithm provider 130, a transport layer security (TLS) configuration manager 135, and a data transmitter 140. Information handling system 150 includes a receiver application 155, a processor 185, and a memory 190. Receiver application 155 includes a data receiver manager 160, a digital signature verifier 165, a hashing algorithm verifier 170, a TLS configuration manager 175, and a data manager 180. The components of environment 100 may be implemented in hardware, software, firmware, or any combination thereof. The components shown are not drawn to scale and environment 100 may include additional or fewer components.

Sender application 110 may be coupled or connected to processor 145 and memory 147. Similarly, receiver application 155 may be coupled or connected to processor 185 and memory 190. However, any variety of connections between sender application 110 and other components of information handling system 105 are envisioned as falling within the scope of the present disclosure. As such, any variety of connections between receiver application 155 and other components of information handling system 150 are envisioned as falling within the scope of the present disclosure. In addition, connections between components may be omitted for descriptive clarity. The operations described herein as being performed by sender application 110 may be performed or executed by processor 145. Similarly, processor 185 may perform any suitable operations to execute receiver application 155. Processors 145 and 185 are similar to processors 302 and 304 of FIG. 4. Memories 147 and 190 are similar to memory 320 of FIG. 3.

In the current world, the use of information handling systems, such as servers has become essential. The use of information handling systems continues to increase due to various reasons, such as digital transformation, cloud computing, increased data generation, remote work, enhanced application requirements, scalability needs, cybersecurity measures, data and analytics, shared resource usage, etc. When an information handling system reaches the end of life (EOL), the information handling system is typically replaced with an information handling system with later technology, also referred to as a new generation information handling system. The EOL information handling system may also be referred to herein simply as an old information handling system. When the new generation information handling system is configured, there may be a need to migrate data from the information handling system that reached its EOL, also referred to as an EOL information handling system, to the new generation information handling system or simply as the new information handling system.

Data integrity is one of several key features when the data is migrated from one information handling system to another information handling system. However, this may cause some difficulty because the security configuration between the EOL information handling system and the new information handling system may be different. For example, the information handling system initiating the data transfer may use older generation security configuration and does not have libraries built in associated with newer generation security configuration. In addition, there may be security issues during the transfer of data over a network from the EOL information handling system to the new information handling system. For example, the data may be vulnerable to a security attack during the transfer. In one particular example, the data packets transmitted via the network may be vulnerable to packet sniffing where the data packets are intercepted and analyzed to collect sensitive information, such as passwords or other personal data.

The data packets may also be vulnerable to a man-in-the-middle attack where an attacker secretly intercepts and modifies the data packets. In addition, the data packet transmission may also be vulnerable to packet injection where an attacker injects malicious data packets into the network to disrupt services. Further, the data packet transmission may be vulnerable to denial of service attack where an attacker can send a flood of data packets to overwhelm a target server, network, or service causing it to become slow or unavailable. Thus, it is very important to check the data integrity of the data during and/or after the data transfer or migration. Accordingly, the present disclosure provides a system and method to prevent various kinds of security attacks and eases the data transfer from an EOL information handling system to a new information handling system even if the security configuration is different between the EOL information handling system and the new information handling system.

Information handling system 105 may be a server that is at its EOL and as such, its data may be transferred to another information handling system such as information handling system 150. These two information handling systems may have different platforms or security configurations, such as different cryptographic protocols and/or cryptographic hashing algorithms. For example, information handling system 105 may use a secure socket layer (SSL) protocol when transporting data over a network while information handling system 150 may use a transport layer security (TLS) protocol. In another example, information handling system 105 may use a different cryptographic hashing algorithm from information handling system 150. Those of ordinary skill in the art will appreciate that the data transfer between two information handling systems may be performed in various scenarios other than when the information handling system is EOL.

Sender application 110 is also referred to as a client application, and receiver application 155, also referred to herein as a server application, may be configured to consume digital signatures, certificates, and hashing algorithms to ensure data integrity of data packets transmitted between information handling system 105 and information handling system 150. A digital signature may be used to verify that the data has not been altered during the transmission. Each data packet can be digitally signed using a private key, and the recipient can verify the digital signature using the sender's public key. A certificate, such as a secure socket layer (SSL) certificate and/or TLS certificate may be used to authenticate the source of the data packets. A hashing algorithm may be used to verify that the data or payload in the data packet has not been modified.

Sender application 110 may be any system or application configured to compute a hash of the payload of the data packet and send the hash along with the data packet. The hash may be included in the header of the data packet. Receiver application 155 may be any system or application configured to compute a hash of the payload in the data packet received and compare the computed hash with the hash received in the header of the data packet from sender application 110 to verify the data integrity of the data packet.

Data transmission manager 120 may be any service, application, or module configured to transmit data to receiver application 155 in small chunks. Data transmission manager 120 via data transmitter 140 may break down the data to be transferred, such as data files into small chunks of data packets. Each data packet may be digitally signed according to an expected configuration of receiver application 155. The expected configuration may have been received via a handshake between sender application 110 and receiver application 155. Data transmission manager 120 may be configured to calculate a hash of the data packet and add the hash as a security header before sending the data packet to receiver application 155 or data receiver manager 160 in particular. In particular, when the data packet is digitally signed and the security header with the security configuration information is added, data transmission manager 120 may send the data packet to receiver application 155 over a secure channel, such as one created by using TLS v1.2 protocol or similar.

Digital signature provider 125 may be any service, application, or module configured to help data transmission manager 120 digitally sign each one of the data packets before transmission. A certificate name and digest algorithm used to digitally sign the data packets may be chosen and provided by digital signature provider 125 based on a direction from data transmission manager 120. The direction may be based on the configuration requested by receiver application 155 during the handshake. For example, data transmission manager 120 may direct digital signature provider 125 to use SHA-512 as the cryptographic algorithm and a particular certificate authority (CA) when signing the data packet or its payload. Based on this example, digital signature provider 125 may then determine whether information handling system 105 has libraries associated with the cryptographic algorithm SHA-512. If information handling system 105 does not have the appropriate libraries, then digital signature provider 125 may download the libraries associated with the cryptographic algorithm SHA-512 and then sign the payload and/or data packets using the downloaded libraries.

Hashing algorithm provider 130 may be any service, application, or module configured to help data transmission manager 120 calculate the hash of the payload of each data packet and add the hash to a security header of the data packet before transmitting the data packet. Data transmission manager 120 may direct hashing algorithm provider 130 to use a particular hashing algorithm in calculating the hash of the payload based on the configuration requested by receiver application 155 during the handshake. Similar to the above, hashing algorithm provider 130 may determine whether information handling system 105 has the appropriate libraries and use them for the calculation. Otherwise, hashing algorithm provider 130 may download the libraries associated with the expected cryptographic hashing algorithm.

TLS configuration manager 135 may be any service, application, or module configured to help data transmission manager 120 in configuring a secure interface or channel between sender application 110 and receiver application 155. The secure channel may be utilized for the transmission of the data packets according to the configuration expected by receiver application 155. For example, TLS configuration manager 135 may configure a secure interface or channel for a TLS data packet transmission as directed by data transmission manager 120. Data transmitter 140 may be any service, application, or module configured to transmit the data packets to receiver application 155 from sender application 110. Data transmitter 140 may also divide the data to be transferred into the data packets.

Data receiver manager 160 may be any service, application, or module configured to receive each data packet sent by sender application 110. When each one of the data packets is received, data receiver manager 160 may validate the integrity of data in the data packet by verifying the digital signature and/or the hash placed in the security header. If the data integrity is validated, then data receiver manager 160 may save the data packet in a memory 190 or a data store of information handling system 150. Data receiver manager 160 may also be responsible to re-create the original data, such as the original data file that was broken down into the data packets by joining each data packet received from sender application 110.

Digital signature verifier 165 may be any system, application, or module configured to help data receiver manager 160 verify the digital signature of each data packet received. The verification may include confirming that the digital signature is authentic and has not been tampered with using a public key associated with the private key of information handling system 105 and/or sender application 110. The digital signature verification may be performed as part of checking the data integrity of each data packet received by data receiver manager 160. For example, the digital signature may be used to protect the data integrity of the hash and/or the data packet.

Hashing algorithm verifier 170 may be any service, application, or module configured to help data receiver manager 160 extract the hash included in the security header of the data packet and verify by recalculating the hash of the payload in the received data packet. Hashing algorithm verifier 170 may compare the recalculated hash with the hash included in the security header of the received data packet. If the hash values match, then the data packet has not been altered. If the hash values do not match, then the data packet has been corrupted.

TLS configuration manager 175 may be any service, application, or module configured to help configure a secure data communication channel between sender application 110 and receiver application 155. In some embodiments, the secure data channel may be established when the handshake between information handling system 105 and information handling system 150 is successful.

Data manager 180 may be any service, application, or module configured to organize each one of the data packets received, wherein the data integrity of the data included in the data packet has been verified. Data manager 180 may re-create the original data, such as the original data file based on the verified data packets.

Those of ordinary skill in the art will appreciate that the configuration, hardware, and/or software components of environment 100 depicted in FIG. 1 may vary. For example, the illustrative components within environment 100 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

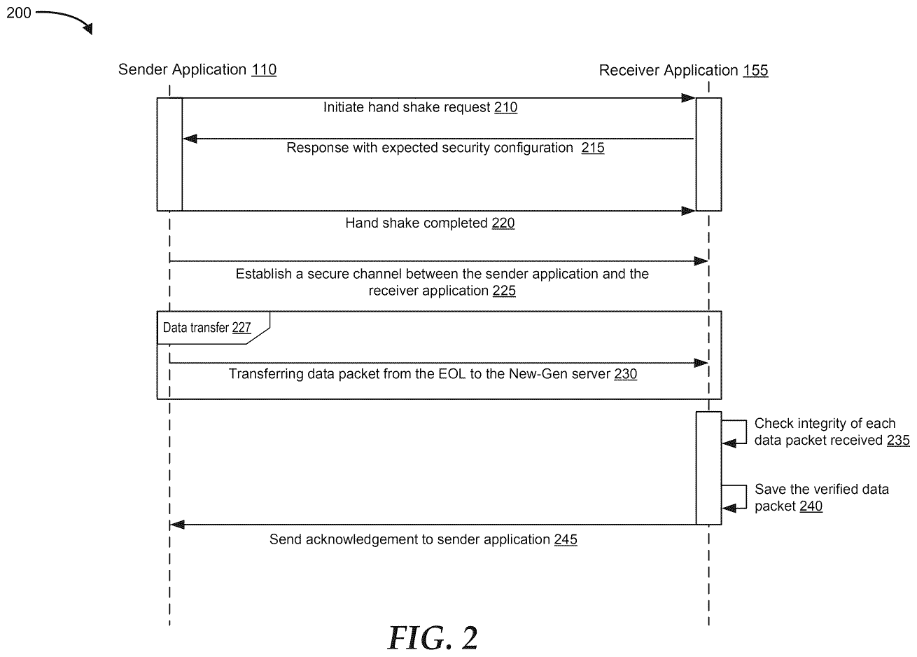

FIG. 2 illustrates a portion of a sequence diagram of a method 200 for data integrity validation during the migration of data between information handling systems, according to an embodiment of the present disclosure. In an example, method 200 may be performed by any suitable component including, but not limited to, sender application 110 and receiver application 155 of FIG. 1. It will be readily appreciated that not every operation set forth in this sequence diagram is always necessary and that certain operations may be combined, performed simultaneously, in a different order, or perhaps omitted, without varying from the scope of the disclosure. In addition, while embodiments of the present disclosure are described in terms of environment 100 of FIG. 1, it should be recognized that other systems may be utilized to perform the described method. One of skill in the art will appreciate that this sequence diagram explains a typical example, which can be extended to applications or services in practice.

Method 200 may be utilized to securely transfer data from a source to a destination when both entities have different security configurations. In one example, method 200 may be utilized to transfer data packets from an information handling system, such as information handling system 105 to another information handling system, such as information handling system 150. In one example, data of a server that is EOL may be migrated to another server, which can be a new generation server.

Method 200 typically starts at operation 210 wherein sender application 110 or data transmission manager in particular may initiate a handshake with a data transfer request to receiver application 155 or a data receiver manager in particular. At operation 215, receiver application 155 may send a response with its expected security configuration of the data transfer. The response may be in various formats, such as an extensible markup language (XML) format, a JavaScript Object Notation (JSON) format, or similar. An example of a portion of the response in the JSON format is shown below. In this example, the expected configuration includes using an expected cryptographic hashing algorithm, such as a secure hash algorithm (SHA) like SHA-256 or SHA-512 as a digital signature digest algorithm and TLS version 1.2 for encryption of data packets transmitted. Other information may be included in the response.

{
″TLS version″: ″1.2″,
″Hashing Algorithm″: ″SHA-512″,
″Digital Signature ″: { ″CN″: ″Technologies LTD″, ″Digest Algorithm″:
″SHA-512″,
“Digest Algorithm″: ″SHA-512″, }
}

At operation 220, when the handshake between sender application 110 and receiver application 155 is completed successfully, a secure data communication channel may be established between sender application 110 and receiver application 155 for the data transfer at operation 225. The secure data communication channel may be created by a TLS configuration manager associated with sender application 110 and receiver application 155. Once the data transfer is completed, the TLS configuration managers may remove the secure data communication channel. At operation 227, sender application 110 may perform a data transfer or data migration of its data to receiver application 155. The data transfer may include breaking down data to be transferred, such as data files, into data packets by data transmitter 140. The data transfer of the data packets until all of the data intended to be transferred has been transferred successfully to receiver application 155.

At operation 230, sender application 110 or in particular a data transmitter module may transmit data packets, also referred to as a network packet, over the secure data communication channel to receiver application 155. The data packets transmitted over this secure channel may be encrypted, such as using TLS version 1.2 based on the expected configuration of receiver application 155 provided during the handshake. The data packets may also be digitally signed. In addition, a hash of a payload of the data packet may be calculated. The hash may be included in a header of the data packet. The header may also include information regarding the security configuration of the data packet. For example, the header may include information regarding the cryptographic protocols and/or cryptographic hashing algorithms. In a particular example, the header may include information on the particular TLS version, such as TLS version 1.2, and indicate that SHA-512 was used for the digital signature and hashing algorithm.

At operation 235, receiver application 155 or data receiver manager 160 in particular may receive each packet from sender application 110. Upon receipt, receiver application 155 or digital signature verifier and hashing algorithm verifier, in particular, may verify the data integrity of the data packet. The data integrity of the data packet may be verified by validating the digital certificate and/or hash of the payload in the data packet. For example, the data receiver manager may direct the digital signature verifier to verify the digital signature of the data packet using the information in the header of the data packet. In addition, the data receiver manager may direct the hashing algorithm verifier to verify the hash of the payload of the data packet based on the information in the header data packet. For example, the data receiver manager may direct the hashing algorithm verifier to recalculate the hash using SHA-512. If data integrity is verified, that is the payload is intact, then the data packet may be accepted and saved in the information handling system that is hosting receiver application 155 at operation 240. For example, the data packet may be stored in memory until all the data packets are received and the original data stored in the information handling system hosting sender application 110 has been re-created by a data manager, such as data manager 180 of FIG. 1. The re-created data may be stored in a non-volatile memory, file system, data store, or similar. Otherwise, the data packet may be discarded.

For each data packet that is accepted or discarded by receiver application 155, the receiver application may send an acknowledgment to sender application 110, at operation 245. After receiving the acknowledgment, sender application 110 may start processing and transmitting the next data packet to receiver application 155. This process may continue until all the data packets have been transmitted from the information handling system 105 hosting sender application 110 to the information handling system that is hosting receiver application 155.

FIG. 3 illustrates an embodiment of an information handling system 300 including processors 302 and 304, a chipset 310, a memory 320, a graphics adapter 330 connected to a video display 334, a non-volatile RAM (NVRAM) 340 that includes a basic input and output system/extensible firmware interface (BIOS/EFI) module 342, a disk controller 350, a hard disk drive (HDD) 354, an optical disk drive (ODD) 356, a disk emulator 360 connected to a solid-state drive (SSD) 364, an I/O interface 370 connected to an add-on resource 374 and a trusted platform module (TPM) 376, a network interface 380, and a BMC 390. Processor 302 is connected to chipset 310 via processor interface 306, and processor 304 is connected to the chipset via processor interface 308. In a particular embodiment, processors 302 and 304 are connected together via a high-capacity coherent fabric, such as a HyperTransport link, a QuickPath Interconnect, or the like. Chipset 310 represents an integrated circuit or group of integrated circuits that manage the data flow between processors 302 and 304 and the other elements of information handling system 300. In a particular embodiment, chipset 310 represents a pair of integrated circuits, such as a northbridge component and a southbridge component. In another embodiment, some or all of the functions and features of chipset 310 are integrated with one or more of processors 302 and 304.

Memory 320 is connected to chipset 310 via a memory interface 322. An example of memory interface 322 includes a DDR memory channel and memory 320 represents one or more DDR DIMMs. In a particular embodiment, memory interface 322 represents two or more DDR channels. In another embodiment, one or more of processors 302 and 304 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 320 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 330 is connected to chipset 310 via a graphics interface 332 and provides a video display output 336 to a video display 334. An example of a graphics interface 332 includes a PCIe interface and graphics adapter 330 can include a four-lane (x4) PCIe adapter, an eight-lane (x8) PCIe adapter, a 16-lane (x16) PCIe adapter, or another configuration, as needed or desired. In a particular embodiment, graphics adapter 330 is provided down on a PCB. Video display output 336 can include a Digital Video Interface (DVI), a High-Definition Multimedia Interface (HDMI), a DisplayPort interface, or the like, and video display 334 can include a monitor, a smart television, an embedded display such as a laptop computer display, or the like.

NVRAM 340, disk controller 350, and I/O interface 370 are connected to chipset 310 via an I/O channel 312. An example of I/O channel 312 includes one or more point-to-point PCIe links between chipset 310 and each of NVRAM 340, disk controller 350, and I/O interface 370. Chipset 310 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 340 includes BIOS/EFI module 342 that stores machine-executable code (BIOS/EFI code) that operates to detect the resources of information handling system 300, to provide drivers for the resources, to initialize the resources, and to provide common access mechanisms for the resources. The functions and features of BIOS/EFI module 342 will be further described below.

Disk controller 350 includes a disk interface 352 that connects the disc controller to a hard disk drive (HDD) 354, to ODD 356, and to disk emulator 360. An example of disk interface 352 includes an Integrated Drive Electronics (IDE) interface, an Advanced Technology Attachment (ATA) such as a parallel ATA (PATA) interface or a SATA interface, a SCSI interface, a USB interface, a proprietary interface, or a combination thereof. Disk emulator 360 permits SSD 364 to be connected to information handling system 300 via an external interface 362. An example of external interface 362 includes a USB interface, an institute of electrical and electronics engineers (IEEE) 1394 (Firewire) interface, a proprietary interface, or a combination thereof. Alternatively, SSD 364 can be disposed within information handling system 300.

I/O interface 370 includes a peripheral interface 372 that connects the I/O interface to add-on resource 374, to TPM 376, and to network interface 380. Peripheral interface 372 can be the same type of interface as I/O channel 312 or can be a different type of interface. As such, I/O interface 370 extends the capacity of I/O channel 312 when peripheral interface 372 and the I/O channel are of the same type, and the I/O interface translates information from a format suitable to the I/O channel to a format suitable to the peripheral interface 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board, or add-in card disposed within information handling system 300, a device that is external to the information handling system, or a combination thereof.

Network interface 380 represents a network communication device disposed within information handling system 300, on a main circuit board of the information handling system, integrated onto another component such as chipset 310, in another suitable location, or a combination thereof. Network interface 380 includes a network channel 382 that provides an interface to devices that are external to information handling system 300. In a particular embodiment, network channel 382 is of a different type than peripheral interface 372 and network interface 380 translates information from a format suitable to the peripheral channel to a format suitable to external devices.

In a particular embodiment, network interface 380 includes a NIC or host bus adapter (HBA), and an example of network channel 382 includes an InfiniBand channel, a Fibre Channel, a Gigabit Ethernet channel, a proprietary channel architecture, or a combination thereof. In another embodiment, network interface 380 includes a wireless communication interface, and network channel 382 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 382 can be connected to an external network resource (not illustrated). The network resource can include another information handling system, a data storage system, another network, a grid management system, another suitable resource, or a combination thereof.

BMC 390 is connected to multiple elements of information handling system 300 via one or more management interface 392 to provide out-of-band monitoring, maintenance, and control of the elements of the information handling system. As such, BMC 390 represents a processing device different from processor 302 and processor 304, which provides various management functions for information handling system 300. For example, BMC 390 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 390 can vary considerably based on the type of information handling system. BMC 390 can operate in accordance with an Intelligent Platform Management Interface (IPMI). Examples of BMC 390 include an Integrated Dell® Remote Access Controller (iDRAC).

Management interface 392 represents one or more out-of-band communication interfaces between BMC 390 and the elements of information handling system 300 and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 105, that is apart from the execution of code by processors 302 and 304 and procedures that are implemented on the information handling system in response to the executed code.

BMC 390 operates to monitor and maintain system firmware, such as code stored in BIOS/EFI module 342, option ROMs for graphics adapter 330, disk controller 350, add-on resource 374, network interface 380, or other elements of information handling system 300, as needed or desired. In particular, BMC 390 includes a network interface 394 that can be connected to a remote management system to receive firmware updates, as needed or desired. Here, BMC 390 receives the firmware updates, stores the updates to a data storage device associated with the BMC, and transfers the firmware updates to NVRAM 340 of the device or system that is the subject of the firmware update, thereby replacing the currently operating firmware associated with the device or system, and reboots information handling system, whereupon the device or system utilizes the updated firmware image.

BMC 390 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 390, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 390 is included on a main circuit board (such as a baseboard, a motherboard, or any combination thereof) of information handling system 300 or is integrated onto another element of the information handling system such as chipset 310, or another suitable element, as needed or desired. As such, BMC 390 can be part of an integrated circuit or a chipset within information handling system 300. An example of BMC 390 includes an iDRAC, or the like. BMC 390 may operate on a separate power plane from other resources in information handling system 300. Thus BMC 390 can communicate with the management system via network interface 394 while the resources of information handling system 300 are powered off. Here, information can be sent from the management system to BMC 390 and the information can be stored in a RAM or NVRAM associated with the BMC. Information stored in the RAM may be lost after power-down of the power plane for BMC 390, while information stored in the NVRAM may be saved through a power-down/power-up cycle of the power plane for the BMC.

Information handling system 300 can include additional components and additional buses, not shown for clarity. For example, information handling system 300 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 300 can include multiple CPUs and redundant bus controllers. One or more components can be integrated together. Information handling system 300 can include additional buses and bus protocols, for example, I²C and the like. Additional components of information handling system 300 can include one or more storage devices that can store machine-executable code, one or more communications ports for communicating with external devices, and various input and output (I/O) devices, such as a keyboard, a mouse, and a video display.

For purposes of this disclosure, information handling system 300 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 300 can include processing resources for executing machine-executable code, such as processor 302, a programmable logic array (PLA), an embedded device such as a System-on-a-Chip (SoC), or other control logic hardware. Information handling system 300 can also include one or more computer-readable media for storing machine-executable code, such as software or data.

Although FIG. 2 shows an example operation of method 200 in some implementations, method 200 may include additional blocks, fewer blocks, different blocks, or differently arranged blocks than those depicted in FIG. 2. Those skilled in the art will understand that the principles presented herein may be implemented in any suitably arranged processing system. Additionally, or alternatively, two or more of the blocks of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
initiating a data transfer request from a first information handling system to a second information handling system;
receiving a response to the data transfer request from the second information handling system, wherein the response includes security configuration information;
subsequent to the receiving of the response, establishing a secure data channel between the first information handling system and the second information handling system based on the security configuration information; and
transferring data from the first information handling system to the second information handling system via the secure data channel.

2. The method of claim 1, wherein the transferring of the data utilizes a cryptographic protocol based on the security configuration information.

3. The method of claim 1, further comprising breaking down the data prior to the transferring of the data.

4. The method of claim 1, further comprising calculating a hash of a payload of a data packet.

5. The method of claim 4, wherein the calculating of the hash is based on a cryptographic hashing algorithm according to the security configuration information.

6. The method of claim 4, further comprising digitally signing the data packet.

7. The method of claim 1, further comprising in response to receiving an acknowledgment associated with a data packet received from the second information handling system, transmitting another data packet to the second information handling system.

8. An information handling system, comprising:
a processor; and
a memory coupled to the processor, the memory having program instructions stored thereon that upon execution cause the processor to:
initiate a data transfer request from a first information handling system to a second information handling system;
receive a response to the data transfer request from the second information handling system, wherein the response includes security configuration information;
subsequent to the receipt of the response, establish a secure data channel between the first information handling system and the second information handling system based on the security configuration information; and
transfer data from the first information handling system to the second information handling system via the secure data channel.

9. The information handling system of claim 8, wherein the transfer of the data utilizes a cryptographic protocol based on the security configuration information.

10. The information handling system of claim 8, wherein the program instructions further cause the processor to break down the data prior to the transfer of the data.

11. The information handling system of claim 8, wherein the program instructions further cause the processor to calculate a hash of a payload of a data packet.

12. The information handling system of claim 11, wherein the calculation of the hash is based on a cryptographic hashing algorithm according to the security configuration information.

13. The information handling system of claim 8, wherein the program instructions further cause the processor to in response to receipt of an acknowledgment associated with a data packet received from the second information handling system, transmit another data packet to the second information handling system.

14. A non-transitory computer-readable medium to store instructions that are executable to perform operations comprising:
initiating a data transfer request from a first information handling system to a second information handling system;
receiving a response to the data transfer request from the second information handling system, wherein the response includes security configuration information;
subsequent to the receiving of the response, establishing a secure data channel between the first information handling system and the second information handling system based on the security configuration information; and
transferring data from the first information handling system to the second information handling system via the secure data channel.

15. The non-transitory computer-readable medium of claim 14, wherein the transferring of the data utilizes a cryptographic protocol based on the security configuration information.

16. The non-transitory computer-readable medium of claim 14, wherein the operations further comprise breaking down the data prior to the transferring of the data.

17. The non-transitory computer-readable medium of claim 14, wherein the operations further comprise breaking down the data prior to the transfer of the data.

18. The non-transitory computer-readable medium of claim 14, wherein the operations further comprise calculating a hash of a payload of a data packet.

19. The non-transitory computer-readable medium of claim 18, wherein the calculating of the hash is based on a cryptographic hashing algorithm according to the security configuration information.

20. The non-transitory computer-readable medium of claim 14, wherein the operations further comprise in response to receiving an acknowledgment associated with a data packet received from the second information handling system, transmitting another data packet to the second information handling system.
